(19) United States
(12) Patent Application Publication
(10) Pub. No.: US 2019/0219759 A1
(43) Pub. Date: Jul. 18, 2019

(54) OPTICAL WAVEGUIDE

(71) Applicant: FUJITSU COMPONENT LIMITED, Tokyo (JP)

(72) Inventor: Rie Tsudome, Tokyo (JP)

(21) Appl. No.: 16/241,134

(22) Filed: Jan. 7, 2019

(30) Foreign Application Priority Data
Jan. 12, 2018 (JP) 2018-003089

(51) Int. Cl. G02B 6/02; G02B 27/09; G02B 6/13

(52) U.S. Cl. CPC G02B 6/021; G02B 6/13; G02B 27/0955

(57) ABSTRACT

An optical waveguide includes one or more cores having a first refractive index, a cladding surrounding the one or more cores and having a second refractive index lower than the first refractive index, and one or more convex lenses disposed, in contact with the respective one or more cores, on an edge face that receives and/or emits light.

### BACKGROUND OF THE INVENTION

### 1. Field of the Invention

The disclosures herein relate to an optical waveguide and a method of making an optical waveguide.

### 2. Description of the Related Art

With increases in the speed of computers, optical communications employing optical signals with capacity for increases in the speed of signal transmission have been becoming widely used. Optical communications use optical fibers and optical waveguides to transmit optical signals. An optical waveguide, which has a plurality of cores and cladding surrounding each core, has a sheet-like shape.

Optical modules for converting electrical signals into optical signals and for converting optical signals into electrical signals are used in optical communications. Optical modules have a light emitting device for converting an electrical signal into an optical signal, a light receiving device for converting an optical signal into an electrical signal, a driver IC (integrated circuit) for driving the light emitting device, a TIA (trans impedance amplifier) for converting electric current into voltage, etc., which are arranged in a case. The light emitting device, the light receiving device, the driver IC, the TIA, and the like are mounted on a print board inside the case. The light emitting device and the light receiving device exchange information based on optical signals with a computer or the like coupled to the optical module through an optical waveguide.

Patent Document 1 discloses an optical waveguide module having a light emitting device and a light receiving device on the surface of a sheet-shaped optical waveguide, which has input and output mirrors and the like.

Light emitted from the edge face of an optical waveguide has a large radiation angle. An attempt to guide this light to a light receiving device generates a significant amount of stray light component, thereby resulting in large optical coupling loss. In consideration of this, a lens may be disposed between the edge face of an optical waveguide and a light receiving device or an optical fiber, so that light emitted from the edge face of the optical waveguide is collected by the lens to enter the light receiving device or the optical fiber.

Providing a lens that is a separate component from the optical waveguide and the like causes an increase in the number of components, which results in a cost increase.

The same applies in the case in which light emitted from a light emitting device or an optical fiber is guided to the edge face of an optical waveguide. Provision of a lens as a separate component causes an increase in the number of components, which results in a cost increase.

There may be a need for a configuration that allows a lens to be provided in an optical waveguide at low cost.

### RELATED-ART DOCUMENTS

### Patent Document

### [Patent Document 1] Japanese Patent Application Publication No. 2016-145907

### [Patent Document 2] Japanese Patent Application Publication No. 2013-217989

### [Patent Document 3] Japanese Patent Application Publication No. 2014-041181

### [Patent Document 4] Japanese Patent Application Publication No. 2014-048493

### [Patent Document 5] Japanese Patent Application Publication No. 2015-197457

### SUMMARY OF THE INVENTION

An optical waveguide includes one or more cores having a first refractive index, a cladding surrounding the one or more cores and having a second refractive index lower than the first refractive index, and one or more convex lenses disposed, in contact with the respective one or more cores, on an edge face that receives and/or emits light.

According to at least one embodiment, a lens is provided in an optical waveguide at low cost.

### BRIEF DESCRIPTION OF THE DRAWINGS

Other objects and further features of the present invention will be apparent from the following detailed description when read in conjunction with the accompanying drawings, in which:

FIGS. 1A and 1B are drawings illustrating an optical waveguide of a first embodiment;

FIGS. 2A and 2B are drawings illustrating the optical waveguide of the first embodiment;

FIGS. 3A through 3D are schematic cross-sectional views illustrating a method of making the optical waveguide of the first embodiment;

FIGS. 4A through 4E are schematic cross-sectional views illustrating a method of making the optical waveguide according to a second embodiment;

FIGS. 5A through 5D are schematic cross-sectional views illustrating a method of making the optical waveguide according to a third embodiment; and

FIGS. 6A and 6B are drawings illustrating an optical waveguide of a fourth embodiment.

### DESCRIPTION OF THE PREFERRED EMBODIMENTS

In the following, embodiments for implementing the invention will be described. The same members or the like are referred to by the same numerals, and a description thereof will be omitted.

### First Embodiment

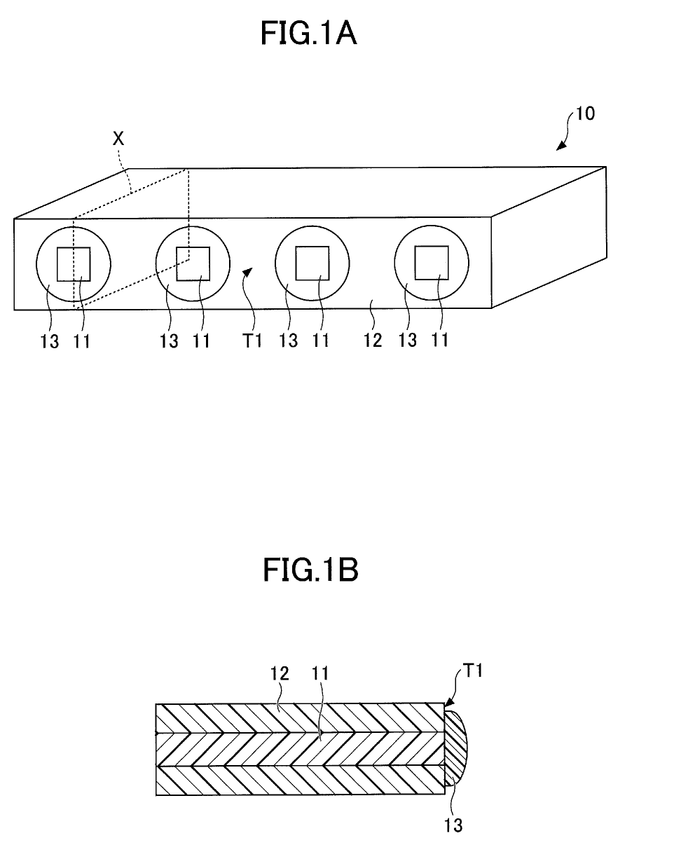

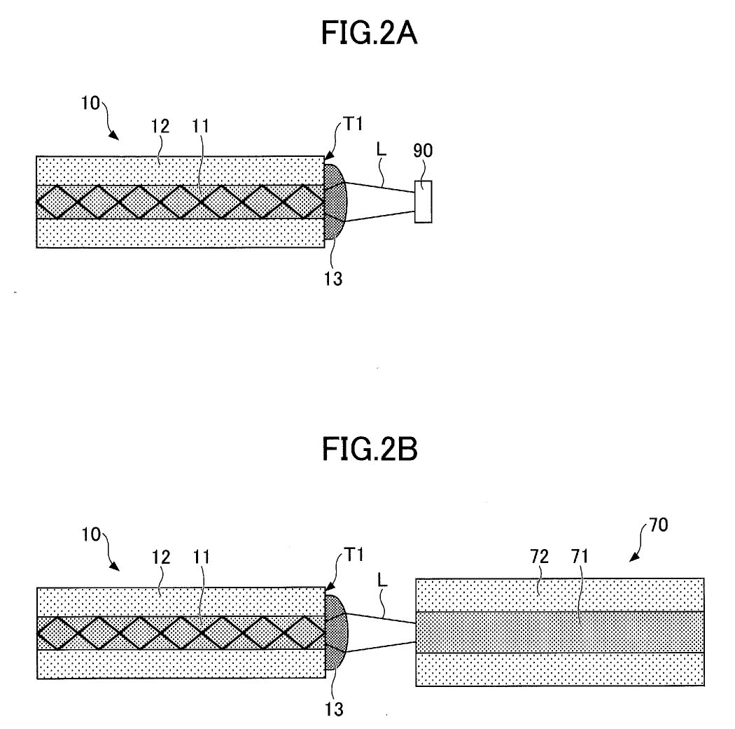

In the following, an optical waveguide of a first embodiment will be described with reference to FIGS. 1A and 1B as well as FIGS. 2A and 2B. FIG. 1A is an axonometric view of an optical waveguide according to a present embodiment. FIG. 1B is a cross-sectional view taken along dotted lines X in FIG. 1A.

An optical waveguide 10 includes a plurality (four in the illustrated example) of cores having a first refractive index and extending alongside each other, and further includes a cladding sheet 12 surrounding the cores 11 and having a second refractive index lower than the first refractive index. The first refractive index may approximately be 1.55, and the second refractive index may approximately be 1.5. The cores 11 and the cladding 12 are made of a resin such as a norbornene resin. Each of the cores 11 as viewed in a cross-section perpendicular to the direction of extension is a square with a side of approximately 1 to 500 micrometers, for example. The cross-sectional shape of the cores 11 may alternatively be a circle or a polygon other than a rectangle.

A surface of the optical waveguide 10 perpendicular to the direction in which the cores 11 extend serves as an edge face T1 of the optical waveguide 10 that emits and/or receives light. At the time of use of the optical waveguide, light enters the cores 11 of the optical waveguide 10 at the edge face T1 so as to propagate through the optical waveguide. Alternatively, light having propagated through the optical waveguide is emitted from the cores 11 of the optical waveguide 10 at the edge face T1. The optical waveguide 10 of the present embodiment has convex lenses 13 disposed in contact with the cores 11 at the edge face T1. The lenses 13 are 1-to-10 times the size of the cores 11 at the edge face T1 to cover the cores 11. The size (i.e., diameter) and curvature of the lenses are designed to enhance the collection efficiency of light emitted from or entering the edge face T1. The lenses 13 are positioned at a proper height to enhance the collection efficiency of light emitted from or entering the edge face T1. The lenses 13 have a third refractive index that is approximately greater than or equal to the first refractive index, and is more preferably greater than the first refractive index. The third refractive index is 1.6 or greater, for example.

The lenses 13 are made of an acrylic resin (with a refractive index of 1.66 to 1.72), an epoxy resin (with a refractive index of 1.60 to 1.63), or a high-refractive-index polymer with a refractive index of 1.9 or greater, or the like, for example. The refractive index of the lenses 13 that is higher than that of the cores 11 increases the collection efficiency of light emitted from or entering the edge face T1. Further, the refractive index of the lenses 13 that is approximately equal to the first index reduces reflection at the interface between the lenses 13 and the cores 11. Forming the lenses with a high-refractive-index resin allows high-refractive-index lenses having a desired size (i.e., diameter) and a desired curvature to be provided at desired positions at low cost.

FIG. 2A illustrates the spread of light L when a light receiving device 90 such as a photodiode receives light emitted from the edge face T1. FIG. 2B illustrates the spread of light L when an optical fiber 70 having a core 71 and cladding 72 receives light emitted from the edge face T1. Despite the fact that the light emitted from the edge face of the optical waveguide has a large radiation angle, the lens 13 collects the light to guide the light to the light receiving device 90 or to the core 71, thereby reducing optical coupling loss. The lenses are disposed directly on the edge face of the optical waveguide that emits and/or receives light, so that optical coupling loss is reduced without incurring a cost increase resulting from an increase in the number of components.

When a light emitting device is provided in place of the light receiving device 90 in FIG. 2A, or when light emitted from an end of the optical fiber 70 is guided to the core 11 in FIG. 2B, the lens 13 collects light from the light emitting device or from the optical fiber 70 to guide the light to the core 11, thereby reducing optical coupling loss similarly to the above-noted configuration.

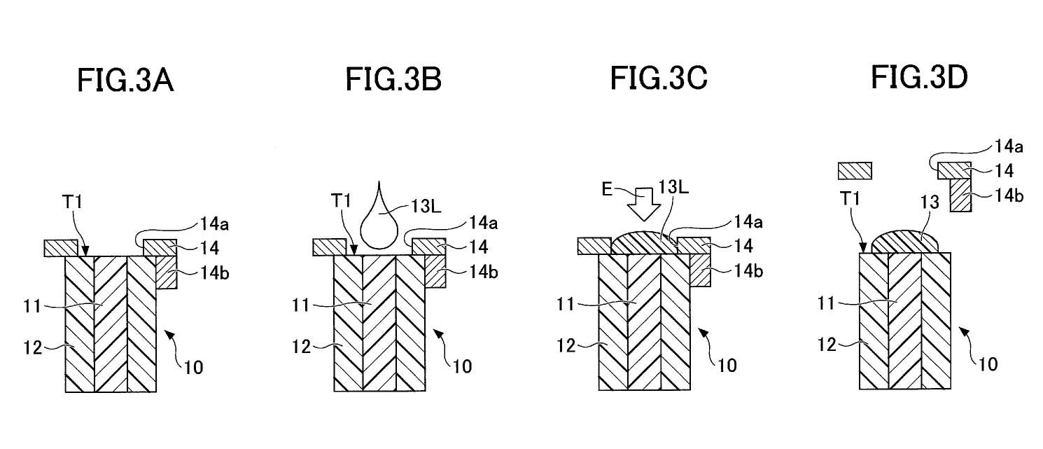

In the following, a method of making the optical waveguide of the present embodiment will be described by referring to FIGS. 3A through 3D. FIGS. 3A through 3D are schematic cross-sectional views illustrating a method of making the optical waveguide of the present embodiment.

As illustrated in FIG. 3A, a metal mask 14 having an opening 14a is aligned to and attached to an area, at which a lens is to be formed, of the edge face T1 inclusive of the face of the core 11. In the present embodiment, the mask 14 has an engaging part 14b, which is engaged with the surface of the cladding sheet 12, thereby allowing the mask to be aligned to the core 11. In so doing, an adhesive agent may be applied to the entire area or part of the contact surface of the edge face T1 or the mask 14, thereby fixedly attaching the mask 14 to the edge face T1. The adhesive agent may have a weak adhesiveness allowing a release at a later process step. A portion of the mask 14 that comes in contact with a liquid resin at the next process step may be given a treatment that reduces wettability with respect to the liquid resin.

Subsequently, as illustrated in FIG. 3B, a dispenser or the like is used to supply an acrylic resin, for example, serving as a liquid resin 13L in the opening 14a of the mask 14.

As illustrated in FIG. 3C, the surface tension of the resin 13L is utilized to give the resin a predetermined curvature. The shape of the resin 13L may be adjusted based on the amount, viscosity, and surface tension of the resin 13L, the size and height of the opening 14a of the mask 14, the wettability of the mask 14 with respect to the resin 13L, etc. The resin 13L in the above-noted state is illuminated with ultraviolet light in the case of an ultraviolet curable resin, or is heated in the case of a thermosetting resin. Exposure to ultraviolet light or to heat causes the resin 13L to cure. In the case of heat being applied, a heat treatment below the maximum withstand temperature of the optical waveguide 10 is performed. When the optical waveguide 10 is made of a norbornene resin, for example, a heat treatment is performed at a temperature lower than 120 degrees Celsius, which is the maximum withstand temperature of such a resin.

Subsequently, as illustrated in FIG. 3D, the mask 14 is removed from the edge face T1 at the point of an adhesive. Consequently, the convex lens 13 in contact with the core 11 is formed on the edge face T1. In this manner, the optical waveguide of the present embodiment is made.

In the method of making an optical waveguide noted above, a surface treatment such as an excimer UV illumination process or a plasma treatment process may be applied, prior to the supply of the resin, to the edge face of the optical waveguide that emits and/or receives light for the purpose of improving adhesion between the edge face and the lenses.

The present embodiment enables the manufacture of an optical waveguide for which optical coupling loss at the edge face for emitting or receiving light is reduced at low cost.

In the case of an optical fiber or a ribbon fiber, for example, simply placing a drop of a liquid resin at the edge face, without using a mask, may create a lens which conforms to the outline of the fiber, such that the pinnacle of the convex lens is positioned at the center of the core. Such a liquid resin is then cured to form a solid lens. Even if the material of the fiber is quartz, the composition thereof is mainly Si—O, which provides satisfactory adhesion to the resin.

In contrast, an optical waveguide has an edge face that is a flat surface. It is thus difficult to form a lens aligned with the center of the core by simply placing a drop of a liquid resin. Some device may be needed to define the outline and position of a lens. Here, the outline of a lens includes the size (i.e., diameter) and curvature of the lens. In the present embodiment, a mask is used to make a lens, which allows a lens to be accurately aligned with respect to the core. The outline of the lens, i.e., the size (diameter) and curvature of the lens, may be adjusted based on the area size and height of the opening of the mask. The optical waveguide is made of a resin, the composition of which is mainly C—H, so that edge face of the optical waveguide is an adhesion resistant surface. A surface treatment such as an excimer UV illumination process or a plasma treatment process may be applied to improve adhesion between the edge face and a resin.

### Second Embodiment

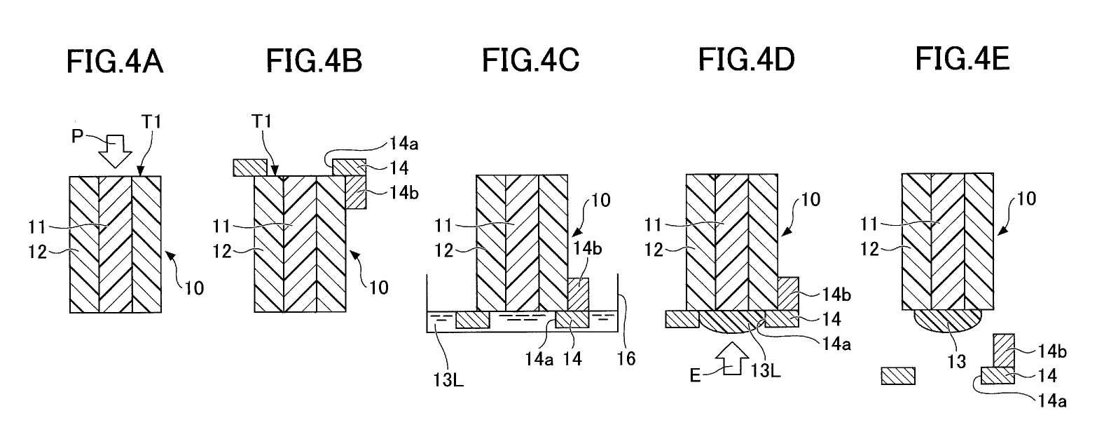

In the following, a method of making the optical waveguide according to a second embodiment will be described by referring to FIGS. 4A through 4E. The structure of the optical waveguide is the same as that of the first embodiment. FIGS. 4A through 4E are schematic cross-sectional views illustrating a method of making the optical waveguide of the present embodiment.

As illustrated in FIG. 4A, a surface treatment P for improving adhesion between the edge face T1 and the lens 13 is applied to the edge face T1 of the optical waveguide 10 that emits and/or receives light. The surface treatment P may be an excimer UV illumination process or a plasma treatment process, for example. The surface treatment P serves to increase the adhesive force of a liquid resin with respect to the edge face T1.

As illustrated in FIG. 4B, a mask 14 having an opening 14a is aligned with the core 11, and is attached to an area, at which a lens is to be formed, of the edge face T1 inclusive of the face of the core 11. The mask 14 is made of a metal, for example. The mask 14 has an engaging part 14b, which is engaged with the surface of the cladding sheet 12, thereby allowing the mask 14 to be aligned to the core 11. In so doing, an adhesive agent may be applied to the entire area or part of the contact surface of the edge face T1 or the mask 14, thereby fixedly attaching the mask 14 to the edge face T1. The adhesive agent may have a weak adhesiveness allowing a release at a later process step. A portion of the mask 14 that comes in contact with a liquid resin at the next process step may be given a treatment that reduces wettability with respect to the liquid resin.

As illustrated in FIG. 4C, the edge face T1 to which the mask 14 is attached is immersed in a liquid resin 13L. To be more specific, the liquid resin 13L is held in a container 16, and the edge face T1 is directed downward and immersed in the resin 13L.

As illustrated in FIG. 4D, the optical waveguide 10 is pulled out of the container 16. As a result, a proper amount of resin 13L is attached to the opening 14a of the mask 14. The surface tension of the resin 13L is utilized to cause the resin to have a predetermined curvature. Due to the surface treatment P performed in advance, the adhesive force of the resin 13L with respect to the edge face T1 is increased. The shape of the resin 13L may be adjusted based on the amount, viscosity, and surface tension of the resin 13L, the size and height of the opening 14a, the wettability of the mask 14 with respect to the resin 13L, etc. The resin 13L in this state is subjected to an ultraviolet light or heat treatment E so as to be cured. In the case of heat being applied, a heat treatment below the maximum withstand temperature of the optical waveguide 10 is performed.

Subsequently, as illustrated in FIG. 4E, the mask 14 is removed from the edge face T1 at the point of an adhesive. Consequently, the convex lens 13 in contact with the core 11 is formed on the edge face T1. In this manner, the optical waveguide of the present embodiment is made.

The present embodiment enables the manufacture of an optical waveguide for which optical coupling loss at the edge face for emitting or receiving light is reduced at low cost.

### Third Embodiment

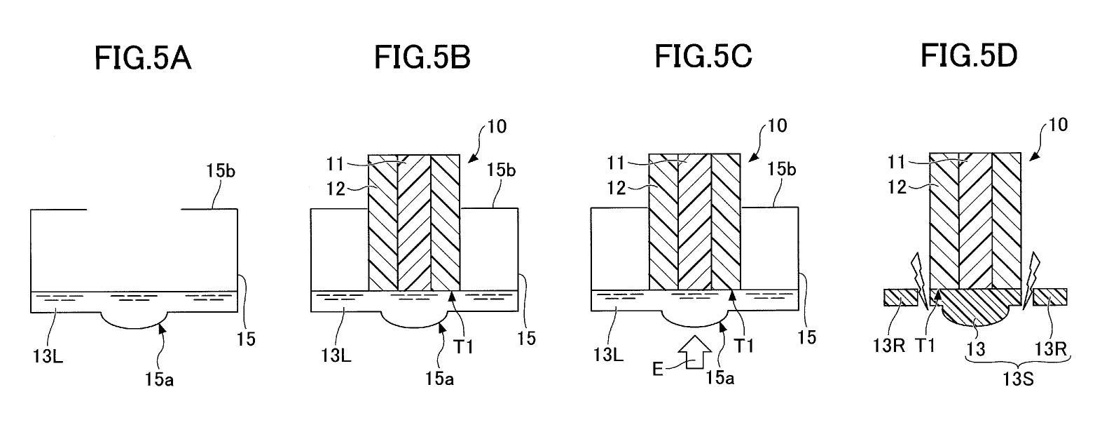

In the following, a method of making the optical waveguide according to a third embodiment will be described by referring to FIGS. 5A through 5D. The structure of the optical waveguide is the same as that of the first embodiment. FIGS. 5A through 5D are schematic cross-sectional views illustrating a method of making the optical waveguide of the present embodiment.

As illustrated in FIG. 5A, a liquid resin 13L is held in a mold 15 which has a concave portion 15a having the shape corresponding to the shape of a convex lens at the bottom surface.

A surface treatment such as an excimer UV illumination process or a plasma treatment process is applied, as needed, to the edge face T1 of the optical waveguide 10 to improve adhesion between the edge face T2 and the lens 13. Thereafter, as illustrated in FIG. 5B, the optical waveguide 10 is positioned such that the core 11 is aligned with the concave portion 15a, and the optical waveguide 10 is inserted into the mold 15, with the edge face t1 first, so as to immerse the edge face T1 in the resin 13L. In the present embodiment, the mold 15 is provided with a positioning part 15b. The cladding sheet 12 closely fits into the positioning part 15b to align the core 11 with the concave portion 15a.

As illustrated in FIG. 5C, the resin 13L in the above-noted state is illuminated with ultraviolet light in the case of an ultraviolet curable resin, or is heated in the case of a thermosetting resin. The resin 13L is cured inside the mold 15 due to the ultraviolet light or heat treatment E. In the case of heat being applied, a heat treatment below the maximum withstand temperature of the optical waveguide 10 is performed.

As illustrated in FIG. 5D, a cured resin 13S and the optical waveguide 10 are separated from the mold 15. Excessive portions 13R of the cured resin 13S are removed as needed. Consequently, the convex lens 13 in contact with the core 11 is formed on the edge face T1. In this manner, the optical waveguide of the present embodiment is made.

The method of making an optical waveguide according to the present embodiment enables the manufacture of an optical waveguide for which optical coupling loss at the edge face for emitting or receiving light is reduced at low cost.

### Fourth Embodiment

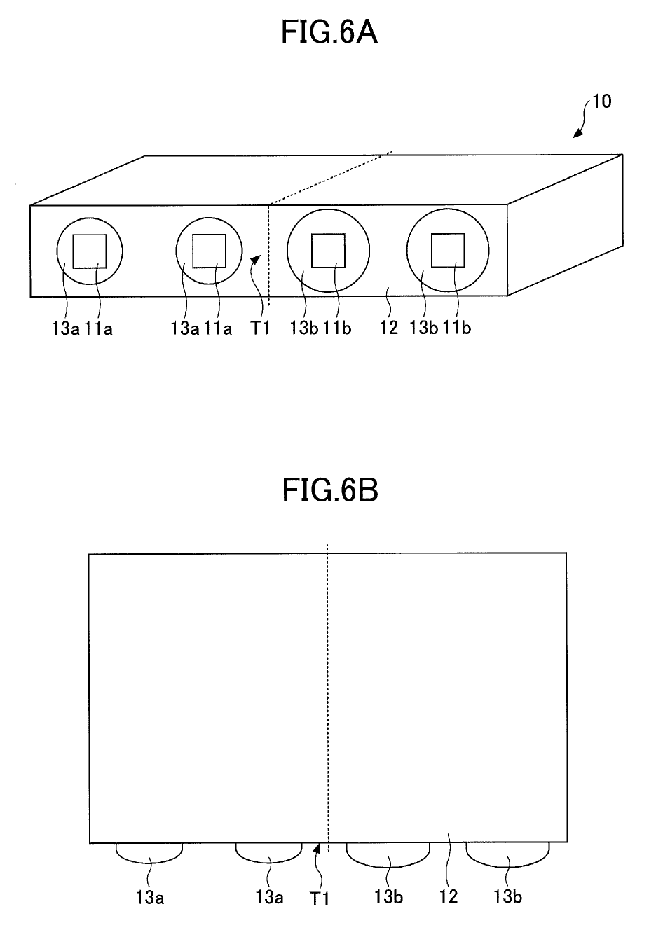

In the following, an optical waveguide according to a fourth embodiment will be described by referring to FIGS. 6A and 6B. FIG. 6A is an axonometric view of an optical waveguide according to the present embodiment. FIG. 6B is a top view of the optical waveguide.

Similarly to the first embodiment, an optical waveguide 10 includes a plurality (four in the illustrated example) of cores 11a and 11b having a first refractive index and extending alongside each other, and further includes a cladding sheet 12 surrounding the cores 11a and 11b and having a second refractive index lower than the first refractive index.

A surface of the optical waveguide 10 perpendicular to the direction in which the cores 11a and 11b extend serves as an edge face T1 of the optical waveguide 10 that emits and/or receives light. The optical waveguide 10 of the present embodiment has convex lenses 13a and 13b disposed in contact with the cores 11a and 11b on the edge face T1.

The lenses 13a and 13b have different outlines and positions. Here, the outline of a lens includes the size (i.e., diameter) and curvature of the lens. The size of the lenses 13a disposed on the cores 11a is smaller than the size of the lenses 13b disposed on the cores 11b. The height of the lenses 13a disposed on the cores 11a is lower than the height of the lenses 13b disposed on the cores 11b. This arrangement is made in order to cope with the circumstances in which different lens sizes and different lens heights are required because the characteristics required for lenses are different between transmission purpose lenses and reception purpose lenses, for example. In this regard, different types of lenses having different characteristics are disposed on the edge face T1. The positions of the lenses 13a and 13b relative to the cores 11a and 11b, respectively, may differ from each other.

Except for what is described above, this embodiment is the same as the first embodiment. Different types of lenses 13a and 13b having different dimensions may be made at the same time by using the same or similar process steps of the first through third embodiments. Lenses having desired different dimensions may be simultaneously made by adjusting the applied amount, viscosity, and surface tension of the resin 13L, the sizes and heights of the openings 14a, the wettability of the mask 14 with respect to the resin 13L, etc.

The above description has been given with respect to an optical waveguide that has lenses whose characteristics are different between transmission and reception of optical signals. This is not a limiting example. The above-noted configuration is applicable to any optical waveguide that has different types of lenses with different characteristics.

Further, the present invention is not limited to these embodiments, but various variations and modifications may be made without departing from the scope of the present invention. The optical waveguides according to the first through fourth embodiments are applicable to various optical apparatuses using an optical waveguide.

The present application is based on and claims priority to Japanese patent application No. 2018-003089 filed on Jan. 12, 2018, with the Japanese Patent Office, the entire contents of which are hereby incorporated by reference.

What is claimed is:

1. An optical waveguide, comprising:
one or more cores having a first refractive index;
a cladding surrounding the one or more cores and having a second refractive index lower than the first refractive index; and
one or more convex lenses disposed, in contact with the respective one or more cores, on an edge face that receives and/or emits light.

2. The optical waveguide as claimed in claim 1, wherein the one or more lenses are different types of lenses having different outlines.

3. A method of making an optical waveguide, the method comprising forming lenses on an edge face of an optical waveguide, the optical waveguide including cores and a cladding surrounding the cores, the cores having a first refractive index, the cladding having a second refractive index lower than the first refractive index, the edge face emitting and/or receiving light, the lenses being in contact with the respective cores.

4. The method as claimed in claim 3, wherein the process of forming lenses includes:
attaching a mask on the edge face, the mask having openings at places where the lenses are to be formed;
supplying a liquid resin to the openings; and
curing the resin.

5. The method as claimed in claim 3, wherein the process of forming lenses includes:
attaching a mask on the edge face, the mask having openings at places where the lenses are to be formed;
immersing, in a liquid resin, the edge face with the mask attached thereto; and
curing the resin.

6. The method as claimed in claim 3, wherein the process of forming lenses includes:
supplying a liquid resin to a mold having a shape corresponding to a shape of the lenses;
inserting the optical waveguide into the mold to immerse the edge face in the liquid resin;
curing the resin inside the mold; and
separating the cured resin and the optical waveguide from the mold.
